(19) United States
(12) Patent Application Publication
(10) Pub. No.: US 2007/0217618 A1
(43) Pub. Date: Sep. 20, 2007

(54) TRANSPORT DEVICE AND ACOUSTIC INSPECTION APPARATUS HAVING SAME

(75) Inventors: Tsung-Lung Yang, Shenzhen (CN); Shih-Chia Chiu, Shenzhen (CN); Shin-Hong Chung, Shenzhen (CN); Rong-Hwa Ding, Shenzhen (CN); Kuan-Hong Hsieh, Shenzhen (CN); Wen-Sheng Tsai, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,894

(22) Filed: Dec. 28, 2006

(30) Foreign Application Priority Data
Mar. 15, 2006 (CN) 200610034452.7

(51) Int. Cl. H04R 29/00

(52) U.S. Cl. 381/58; 381/59; 73/586

(57) ABSTRACT

An acoustic inspection apparatus and its transport device are disclosed. The acoustic inspection apparatus includes an anechoic chamber and a transport device. The anechoic chamber defines an entrance. The transport device includes a support frame, guiding rails, sliding blocks, a motor, and a multiple holder. The guiding rails are mounted on the support frame. The sliding blocks are fitted on the guiding rails. The motor drives the sliding blocks moving along the lengthwise direction of the guiding rails. The multiple holder is connected with the sliding blocks and at least includes an acoustical anechoic chamber cover and a holding platform configured for supporting a sound device that to be inspected. The acoustic inspection apparatus can be used in product line to inspect sound devices.

### BACKGROUND

1. Technical Field

The present invention relates to a transport device and an acoustic inspection apparatus having a transport device.

2. General Background

Sound devices, such as speakers need to be inspected after they are manufactured. Electric acoustic parameters are used to inspect the sound devices. These electric acoustic parameters are tested in an anechoic chamber. Traditional anechoic chamber does not have a transport device. The sound devices are put into or taken out from the anechoic chamber manually. The inspection's efficiency is low and can't reach the need of inspecting sound devices in a product line.

Therefore what is needed is an acoustic inspection apparatus with a transport device.

### SUMMARY

A transport device for acoustic inspection apparatus is disclosed. The transport device includes a support frame, guiding rails, sliding blocks, a motor, and a multiple holder. The guiding rails are mounted on the support frame. The sliding blocks are fitted on the guiding rails. The motor drives the sliding blocks moving along the lengthwise direction of the guiding rails. The multiple holder is connected with the sliding blocks and at least includes an acoustical anechoic chamber cover and a holding platform configured for placing a sound device that to be inspected.

An acoustic inspection apparatus is disclosed. The acoustic inspection apparatus includes an anechoic chamber and a transport device. The anechoic chamber defines an entrance. The transport device includes a support frame, guiding rails, sliding blocks, a motor, and a multiple holder. The guiding rails are mounted on the support frame. The sliding blocks are fitted on the guiding rails. The motor drives the sliding blocks moving along the lengthwise direction of the guiding rails. The multiple holder is connected with the sliding blocks and at least includes an acoustical anechoic chamber cover and a holding platform configured for placing a sound device that to be inspected.

Other advantages and novel features will be drawn from the following detailed description with reference to the attached drawing, in which:

### BRIEF DESCRIPTION OF THE DRAWINGS

FIG. 1 is a schematic, solid view of an acoustic inspection apparatus according to a preferred embodiment of the present invention, including a transport device;

FIG. 2 is a schematic, solid view of a driving part of the transport device of FIG. 1; and

FIG. 3 is a schematic, solid view of a multiple holder of the transport device of FIG. 1.

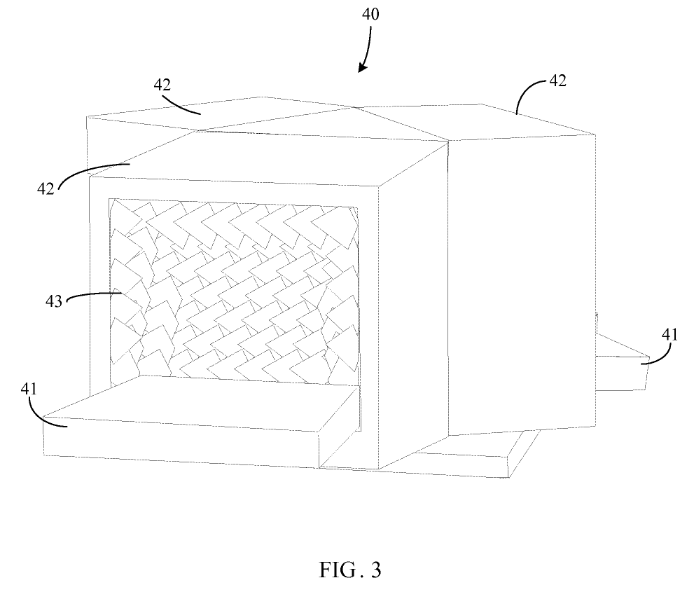

### DETAILED DESCRIPTION OF THE EMBODIMENT

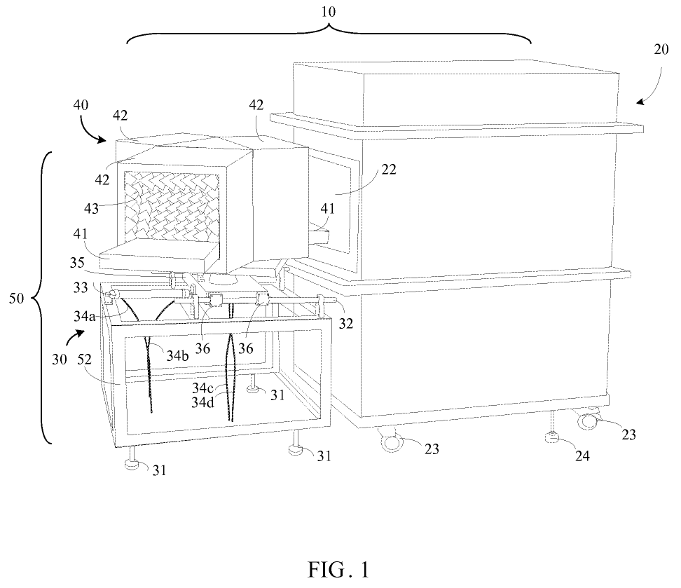

Referring to FIG. 1, an acoustic inspection apparatus 10 is disclosed. The acoustic inspection apparatus 10 includes an anechoic chamber 20 and a transport device 50. The anechoic chamber 20 defines an entrance 22. Wheels 23 and retractable supports 24 are attached beneath the anechoic chamber 20, so that the anechoic chamber 20 can be moved. The transport device 50 includes a retractable platform 30 and a multiple holder 40.

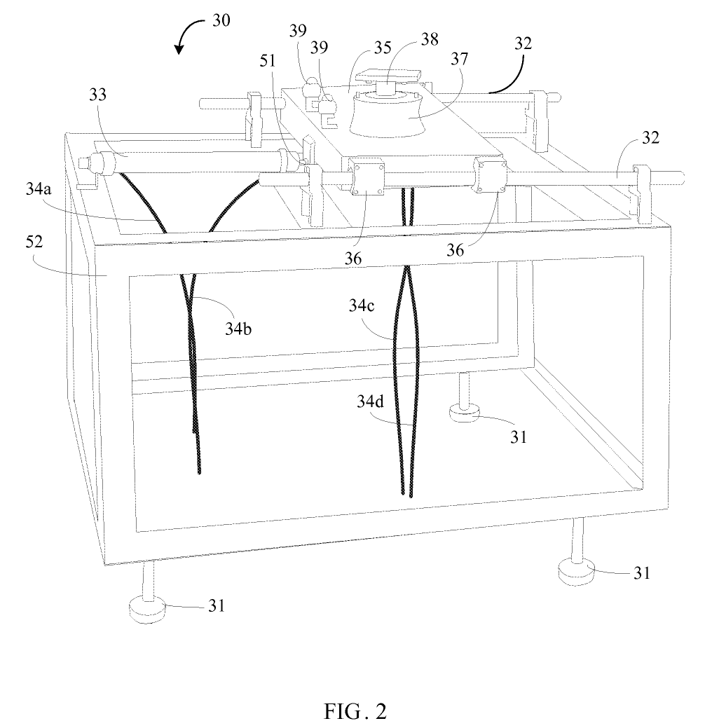

Referring to FIG. 2, the retractable platform 30 is disclosed. The retractable platform 30 includes a support frame 52. Supports 31 are attached beneath the support frame 52. Two guiding rails 32 are attached on the support frame 52. Sliding blocks 36 are respectively fitted on the guiding rails 32. A platform 35 attached with sliding blocks is slidably attached to the guiding rail and is movable along a lengthwise in a direction of the guiding rails 32. A motor 33 is mounted on the support frame 52. In this embodiment of the present invention, the motor 33 is a pneumatic actuator. A piston 51 of the pneumatic actuator 33 is connected with the platform 35. Two air pipes 34a, 34b connect the pneumatic actuator 33 with an air pump (not shown).

The platform 35 is further fitted with a rotator 37 and two wheels 39. In this embodiment of the present invention, the rotator 37 is a rotary pneumatic actuator. Two air pipes 34c, 34d connect the rotary pneumatic actuator 37 with the air pump. The rotary pneumatic actuator 37 is configured to drive a rotor 38.

Referring to FIG. 4, the multiple holder 40 is mounted on the rotor 38 and is supported by the rotor 38 and the wheels 39. The multiple holder 40 includes three acoustical anechoic chamber covers 42 with an holding platform 41. Each anechoic chamber cover 42 is filled with acoustical materials 43, and any two adjacent acoustical anechoic chamber covers 42 have a 120 degree angle therebetween.

When a sound device (not shown) to be inspected is supported on the holding platform 41, the rotary pneumatic actuator 37 rotates the multiple holder 40 so that the acoustical anechoic cover 42 with the sound device faces the entrance 22 perpendicularly. The pneumatic actuator 33 moves the multiple holder 40 along the lengthwise in the direction of the guiding rails 32, thus moving the sound device into the anechoic chamber 20 and seals the entrance 22 of the acoustical anechoic chamber 20 with the anechoic chamber cover 42. The sound device is then inspected in the anechoic chamber 20.

Since the multiple holder 40 has three holding platforms 41, three sound devices can be supported on the multiple holder 40 for inspection successively. The three sound devices can be inspected in a clockwise order or an anticlockwise order. During the inspection, the sound device that has been inspected can be unloaded from the multiple holder 40, and a new sound device that needs to be inspected can be loaded onto the multiple holder 40. In this way, the efficiency of the inspection is improved.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A transport device used in an acoustic inspection apparatus, comprising:
a support frame;
guiding rails mounted on the support frame;
sliding blocks fitted on the guiding rails;
a motor configured for driving the sliding blocks to move along a lengthwise direction of the guiding rails; and
a multiple holder connected with the sliding blocks, comprising at least one acoustical anechoic chamber cover and at least one holding platform, the holding platform being configured for supporting a sound device to be inspected.

2. The transport device of claim 1, further comprising a rotary motor fixed with the sliding blocks, the rotary motor comprising a rotor fixed with the multiple holder.

3. The transport device of claim 2, further comprising wheels connected with the sliding blocks for supporting the multiple holder.

4. The transport device of claim 3, wherein the multiple holder comprises three acoustical anechoic chamber covers and three corresponding holding platforms.

5. The transport device of claim 4, wherein two of the adjacent acoustical anechoic chamber covers have a 120 degree angle therebetween.

6. An acoustical inspection apparatus for inspecting a sound device, comprising:
an anechoic chamber defining an entrance; and
a transport device comprising:
a support frame;
guiding rails mounted on the support frame;
sliding blocks fitted on the guiding rails;
a motor configured for driving the sliding blocks to move along a lengthwise direction of the guiding rails; and
a multiple holder connected with the sliding blocks, comprising at least one acoustical anechoic chamber cover and at least one holding platform, the holding platform configured for supporting the sound device to be inspected.

7. The acoustic inspection apparatus of claim 6, further comprising a rotary motor fixed with the sliding blocks, the rotary motor comprising a rotor fixed with the multiple holder.

8. The acoustic inspection apparatus of claim 7, further comprising wheels connected with the sliding blocks for supporting the multiple holder.

9. The acoustic inspection apparatus of claim 8, wherein the multiple holder includes three acoustical anechoic chamber covers and three corresponding holding platforms.

10. The acoustic inspection apparatus of claim 9, wherein an angle of two of the adjacent acoustical anechoic chamber covers is 120 degree.
